(19) United States
(12) Patent Application Publication
(10) Pub. No.: US 2017/0217808 A1
(43) Pub. Date: Aug. 3, 2017

(54) BIOLOGICAL TREATMENT METHOD AND BIOLOGICAL TREATMENT APPARATUS

(71) Applicant: Kurita Water Industries Ltd., Tokyo (JP)

(72) Inventors: Noriaki ONO, Tokyo (JP); Tetsuro FUKASE, Tokyo (JP); Naoki MATSUTANI, Tokyo (JP)

(21) Appl. No.: 15/500,804

(22) PCT Filed: Jul. 14, 2015
(86) PCT No.: PCT/JP2015/070093

§ 371 Date: Jan. 31, 2017

(30) Foreign Application Priority Data
Sep. 16, 2014 (JP) 2014-187799

(51) Int. Cl. C02F 9/00; C02F 3/00

(52) U.S. Cl. CPC C02F 9/00; C02F 3/006; C02F 1/66

(57) ABSTRACT

Provided is a biological treatment method and an apparatus that allow organic wastewater from a manufacturing process of electronic devices to be neutralized efficiently during its biological treatment with a less neutralizer in contrast to excessive use thereof in the conventional biological treatment and thereby make it possible to reduce an amount of an inorganic coagulant used in the downstream coagulation step and to reduce salt loads in RO membrane separation and ion exchange treatment. Wastewater from a process of manufacturing electronic devices is passed sequentially through two or more biological treatment tanks that include at least two aerobic biological treatment tanks including the final-stage aerobic biological treatment tank while adding a neutralizer to the biological treatment tank or tanks except the final-stage biological treatment tank so that an M-alkalinity of the liquid in the final-stage biological treatment tank is maintained at not more than 50 mg/L as CaCO₃.

### FIELD OF INVENTION

The present invention relates to a method and an apparatus for biological treatment of organic wastewater from a manufacturing process of electronic devices such as semiconductors, liquid crystals and plasma displays. More particularly, the present invention relates to a biological treatment method and an apparatus that allow for a reduction in an amount of an acid or an alkali required for pH adjustment during the biological treatment and thereby make it possible to reduce an

amount of an inorganic coagulant used in a downstream coagulation step and to reduce salt loads in reverse osmosis (RO) membrane separation and ion exchange treatment.

### BACKGROUND OF INVENTION

A manufacturing process of electronic devices such as semiconductors, liquid crystals and electronic displays represented by plasma displays generates wastewaters containing low-molecular weight organic matter, for example, alcohol such as isopropanol, ethanol and methanol, and amines such as monoethanolamine. For the purpose of reuse, such organic wastewater is generally recovered and biologically treated (for example, Patent Document 1). The biologically treated water is further treated by coagulation separation, RO membrane separation and ion exchange treatment, and is recovered for reuse.

The pH in tanks in which organic wastewater is biologically treated is adjusted to optimum pH values depending on the types of biological reactions such as organic matter removal, nitrification and denitrification performed in the tanks. In these biological reactions such as organic matter removal, nitrification and denitrification, the optimum pH value is usually neutral to weakly alkaline (pH 7 to 8.5).

Thus, multistage biological treatment through a plurality of biological treatment tanks involves pH meters in the respective biological treatment tanks, and the pH in each of the biological treatment tanks is adjusted (hereinafter, sometimes written as “neutralized”) to fall in the optimum range of pH values by the addition of an acid or an alkali (hereinafter, sometimes written as the “neutralizer”) to the biological treatment tank.

Patent Document 1: Japanese Patent Publication 2013-22536A

The biological treatment of organic wastewater to remove organic matter generally produces carbon dioxide from the decomposition of the organic matter, resulting in a need of a large amount of an alkali to neutralize the carbon dioxide generated. For example, glucose is biologically decomposed as shown by the following reaction equation, and the resultant carbon dioxide is neutralized with sodium hydroxide (NaOH) into sodium bicarbonate according to the reaction equation below.

C₆H₁₂O₆+6O₂→6H₂O+6CO₂

6CO₂+6NaOH→6NaHCO₃

The decomposition of 180 mg/L glucose produces 322 mg/L carbon dioxide, which consumes 240 mg/L sodium hydroxide to be neutralized. The neutralization produces 504 mg/L sodium bicarbonate. In a downstream coagulation treatment step, the coagulation treatment consumes a substantially equal amount of an inorganic coagulant to the sodium bicarbonate, thus increasing the loads on the downstream RO membrane separation and ion exchange treatment.

When amine-containing wastewater is biologically treated to remove organic matter (BOD) and is further nitrified and denitrified, the amines which provide a high alkalinity are oxidized into nitric acid and hence the final product is NaNO₃. The complete nitrification of amines leads to a significant decrease in pH and brings the M alkalinity to negative. As a result, the M alkalinity is increased only to zero even when NaOH is added in the equimolar amount to the amines. To avoid this, an alkali (for example, sodium hydroxide) is added to produce a slight amount of NaHCO₃ and thereby to keep the pH at neutral. Because the alkali is consumed also by the neutralization of carbon dioxide generated by the decomposition of organic matter during the reaction, the treatment as a whole requires a large amount of alkali.

While the oxidation of amines into nitric acid in a nitrification tank requires an alkali, the denitrification of nitric acid into nitrogen in a denitrification tank involves the addition of an acid. The amount of an acid that is added to the denitrification tank is increased if the amount of an alkali that has been added up to the previous nitrification stage is excessively large.

Organic wastewater from the manufacturing of electronic devices is a mixture of wastewater from the washing of panels or devices with a cleaner such as ultrapure water, and from other washing steps in the manufacturing process. Thus, the content of salts in the organic wastewater is as low as, for example, 100 mg/L or below in terms of salt concentration. When the salt concentration in wastewater is low, the majority of salts present in the biologically treated water is derived from salts added during the wastewater treatment steps, in particular, neutralizers added during the biological treatment steps. Heavy use of neutralizers in the biological treatment of wastewater directly leads to an increase in the salt loads on downstream treatments.

The larger the amounts of neutralizers added in the biological treatment, the larger the amounts of reagents added in downstream treatments to compensate for such heavy use. For example, excessive addition of an alkali in the biological treatment results in an increase in the amount of an inorganic coagulant used to consume the alkali in the downstream coagulation treatment step and also results in an increase in the amount of a regenerant used in the further downstream ion exchange treatment.

Usually, the amounts of neutralizers used in the biological treatment of organic wastewater from the manufacturing of electronic devices represent about 70% of the salt loads in all the steps. Thus, the reduction in the amounts of neutralizers used in the biological treatment is significantly effective for cost saving.

### SUMMARY OF INVENTION

An object of the invention is to provide a biological treatment method and a biological treatment apparatus that allow organic wastewater from the manufacturing of electronic devices to be neutralized efficiently during its biological treatment with a less neutralizer in contrast to the heavy use thereof in the conventional biological treatment and thereby make it possible to reduce the amount of an inorganic coagulant used in the downstream coagulation step and to lessen the salt loads in RO membrane separation and ion exchange treatment.

As will be described below, the present inventors have developed a method that allows the amount of a neutralizer to be reduced without causing a significant decrease in biological activity.

The amount in which a neutralizer is used can be reduced by performing the biological treatment of organic wastewater from the manufacturing of electronic devices in such a manner that the wastewater is passed sequentially through two or more biological treatment tanks that include at least two aerobic biological treatment tanks including the final-stage aerobic biological treatment tank while adding the neutralizer to the biological treatment tank or tanks except the final-stage biological treatment tank so that the M-alkalinity of the liquid in the final-stage biological treatment tank does not exceed a prescribed value.

A summary of the invention is as described below.

[1] A biological treatment method comprising passing organic wastewater from a manufacturing process of electronic devices sequentially through two or more biological treatment tanks arranged in series, wherein

at least two tanks of the two or more biological treatment tanks are aerobic biological treatment tanks,

one of the aerobic biological treatment tanks is a final-stage biological treatment tank,

a pH in at least one biological treatment tank other than the final-stage biological treatment tank is adjusted by adding an acid or an alkali, and

an addition amount of the acid or the alkali is controlled so that an M-alkalinity of a liquid in the final-stage biological treatment tank is maintained at not more than 50 mg/L as CaCO₃.

[2] The biological treatment method according to [1], wherein the addition amount of the acid or the alkali is controlled based on the M-alkalinity of the liquid in the final-stage biological treatment tank or an indicator correlated with the M-alkalinity.

[3] The biological treatment method according to [2], wherein the indicator correlated with the M-alkalinity is the pH of the liquid in the biological treatment tank to which the acid or the alkali is added, and the addition amount of the acid or the alkali is controlled based on a correlation previously determined with respect to the M-alkalinity and the pH.

[4] The biological treatment method according to any one of [1] to [3], wherein the aerobic biological treatment tank(s) other than the final-stage biological treatment tank is a nitrification tank, and the pH in the nitrification tank is controlled to be not less than a prescribed value.

[5] The biological treatment method according to any one of [1] to [4], further comprising subjecting the treated water discharged from the final-stage biological treatment tank to one or more advanced treatment processes selected from coagulation separation, reverse osmosis membrane separation, and ion exchange treatment.

[6] The biological treatment method according to [5], further comprising recovering and reusing the water treated by the advanced treatment process.

[7] A biological treatment apparatus comprising two or more biological treatment tanks arranged in series through which organic wastewater from a process of manufacturing electronic devices is sequentially passed, wherein

at least two tanks of the two or more biological treatment tanks are aerobic biological treatment tanks,

one of the aerobic biological treatment tanks is a final-stage biological treatment tank,

at least one biological treatment tank other than the final-stage biological treatment tank has a pH adjusting unit that adjusts the pH by adding an acid or an alkali, and

the apparatus includes a controller for controlling an addition amount of the acid or the alkali by the pH adjusting unit so that an M-alkalinity of a liquid in the final-stage biological treatment tank is maintained at not more than 50 mg/L as CaCO₃.

[8] The biological treatment apparatus according to [7], wherein the controller controls the addition amount of the acid or the alkali by the pH adjusting unit based on the M-alkalinity of the liquid in the final-stage biological treatment tank or an indicator correlated with the M-alkalinity.

[9] The biological treatment apparatus according to [8], wherein the indicator correlated with the M-alkalinity is the pH of the liquid in the biological treatment tank to which the acid or the alkali is added, and the controller controls the addition amount of the acid or the alkali by the pH adjusting unit based on a correlation previously determined with respect to the M-alkalinity and the pH.

[10] The biological treatment apparatus according to any one of [7] to [9], wherein the aerobic biological treatment tank(s) other than the final-stage biological treatment tank is a nitrification tank, and the apparatus includes a controller that controls the pH in the nitrification tank to be not less than a prescribed value.

[11] The biological treatment apparatus according to any one of [7] to [10], wherein the apparatus includes one or more advanced treatment units selected from a coagulation separation unit, a reverse osmosis membrane separation unit and an ion exchange treatment unit so that the advanced treatment unit treats treated water discharged from the final-stage biological treatment tank.

[12] The biological treatment apparatus according to [11], wherein the apparatus includes a recovery unit that recovers the treated water from the advanced treatment unit so that the water recovered is reused.

### Advantageous Effects of Invention

According to the present invention, organic wastewater from a manufacturing process of electronic devices can be biologically treated while attaining a significant reduction in the amount of a neutralizer as compared to the amounts used in the conventional methods, and consequently the costs associated with biological treatment reagents can be reduced. When the biological treatment involves downstream coagulation treatment, the inventive technique makes it possible to reduce the amount of an inorganic coagulant required for the coagulation treatment. When ion exchange treatment or RO membrane separation treatment is performed in a downstream stage of the biological treatment, the frequency in which the ion exchange resin in the ion exchange treatment is regenerated can be reduced by virtue of the reduction in salt load and, in the RO membrane separation treatment, enhancements in treatment efficiency such as water recovery rate can be obtained.

### BRIEF DESCRIPTION OF DRAWINGS

FIG. 1 is a system diagram of treatment steps in Example 1 and Comparative Example 1.

FIG. 2 is a system diagram of treatment steps in Examples 2 to 4 and Comparative Example 2.

FIG. 3 is a system diagram of treatment steps according to another embodiment for carrying out the present invention.

### DESCRIPTION OF EMBODIMENTS

Embodiments of the present invention will be described in detail hereinbelow.

[Raw Water]

The raw water that is to be treated in the invention is organic wastewater discharged during steps in the manufacturing of electronic devices. The composition and properties of the raw water are not particularly limited. Some general properties are described below.

<Wastewater from Rinsing of Semiconductors with Ultrapure Water>

Conductivity: not more than 100 mS/m

Salt concentration: not more than 0.1 wt %

<Wastewater from Manufacturing of Liquid Crystal Panels>

pH: 8 to 12

TOC: 30 to 2000 mg/L

T-N: 10 to 1000 mg/L

If such organic wastewater contains little phosphorus sources or nitrogen sources which are necessary for biological treatments, the wastewater is biologically treated after phosphorus sources or nitrogen sources are added as required.

[Modes of Biological Treatment]

The biological treatment in the invention is a multistage treatment performed by passing the raw water sequentially through two or more biological treatment tanks arranged in series. In the invention, at least two tanks of the two or more biological treatments are aerobic biological treatment tanks (hereinafter, sometimes written as the “aerobic tanks”) and one of such aerobic tanks is the final-stage biological treatment tank (hereinafter, sometimes written as the “final tank”).

If the final tank is an aerobic tank and the apparatus does not include at least one additional aerobic tank in which alkali addition takes place, the control based on the measurement of M-alkalinity of the liquid in the final tank becomes infeasible. Thus, the multistage biological treatment in the invention is performed using the tanks in which the final tank is an aerobic tank and at least one tank other than the final tank is aerobic.

The mode of biological treatment in the invention is not particularly limited as long as the above requirements are satisfied. Some examples of the modes of biological treatment are described below. The nitrification tank and the reaeration tank are aerobic tanks, and the denitrification tank is an anaerobic biological treatment tank (hereinafter, sometimes written as the “anaerobic tank”).

(1) Aerobic tank→Aerobic tank (→Sedimentation tank)

(2) Aerobic tank→Nitrification tank→Denitrification tank→Reaeration tank (→Sedimentation tank)

(3) Aerobic tank→Nitrification tank→Reaeration tank (→Sedimentation tank)

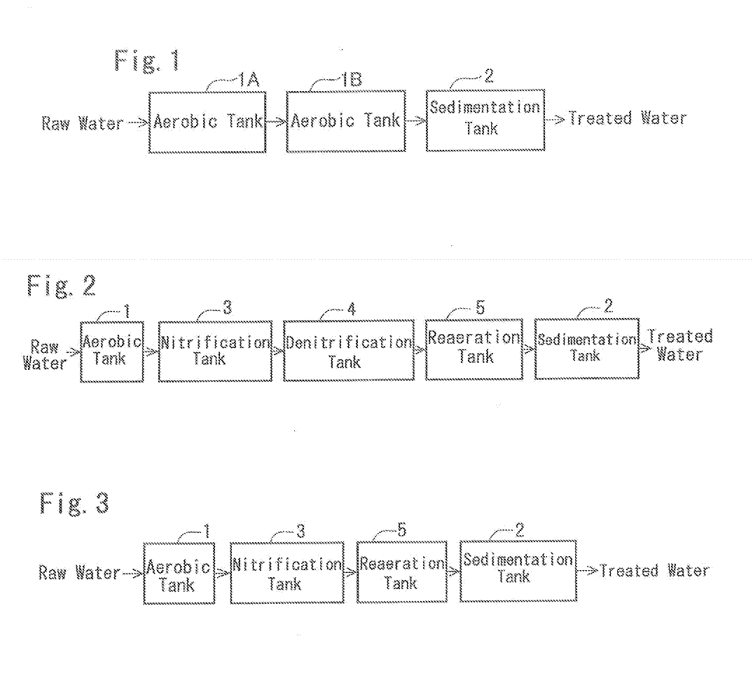

The treatment modes (1) to (3) correspond to FIGS. 1 to 3, respectively. While no sludge return lines are illustrated in the drawings, the system may be one-pass type or circulation type.

[M-Alkalinity in Final Tank]

In the invention, a neutralizer is added to the biological treatment tank or tanks other than the final tank to adjust the pH so that the M-alkalinity of the liquid in the final aerobic tank will be kept at not more than 50 mg/L as CaCO₃.

The M-alkalinity of the liquid in the final tank is not more than 50 mg/L as CaCO₃, and is preferably not more than 30 mg/L as CaCO₃. Any pH adjustment which brings the M-alkalinity to above 50 mg/L as CaCO₃ involves an extremely large amount of an alkali in the upstream biological treatment tanks so that the invention fails to attain a reduction in the amount of neutralizer. If the M-alkalinity is below 0 mg/L as CaCO₃, carbon dioxide dissolved in the liquid is so deficient that the growth of nitrifying bacteria becomes insufficient and nitrification does not occur. Thus, the lower limit of the M-alkalinity of the liquid in the final tank is not less than 0 mg/L as CaCO₃, and preferably not less than 10 mg/L as CaCO₃.

The M-alkalinity of the liquid in the final tank is affected not only by the properties of the raw water but also by other factors such as the degree of aeration and the phosphoric acid concentration in the biological treatment tanks.

Because the final tank is an aerobic tank, a higher dissolved oxygen concentration is more preferable.

[Biological Treatment Tanks to which Neutralizer is Added]

In the invention, the addition of a neutralizer, namely, an acid or an alkali, is made in a biological treatment tank other than the final tank. The neutralizer addition may take place only in one tank, or in two or more tanks.

In the case where the multistage system includes three or more biological treatment tanks, an attempt to perform neutralization by adding an alkali as the neutralizer to the final tank may result in incomplete treatment because no neutralization takes place in the tanks closer to the raw water inlet. The biological treatment in the final tank is not as active as in the other biological treatment tanks, and therefore the biological reaction produces less carbon dioxide and does not require neutralization.

Usually, the biological reaction is most active in the first-stage tank or the second-stage tank. Thus, it is desirable that neutralizer addition takes place in the first-stage biological treatment tank and/or the second-stage biological treatment tank.

In the case of the treatment mode (1), it is preferable that an alkali is added to the upstream aerobic tank.

In the case of the treatment mode (2), it is preferable that an alkali is added to the aerobic tank or to the aerobic tank and the nitrification tank, and an acid is added to the denitrification tank. In the invention, however, the control based on the M-alkalinity of the liquid in the final tank can make it possible to omit the addition of an alkali to the nitrification tank or the addition of an acid to the denitrification tank.

In the case of the treatment mode (3), it is preferable that an alkali is added to the aerobic tank or to the aerobic tank and the nitrification tank. In the invention, similarly to the treatment mode (2), the control based on the M-alkalinity of the liquid in the final tank can make it possible to omit the addition of an alkali to the nitrification tank.

<Neutralization Control Based on M-Alkalinity>

The M-alkalinity, specifically, the concentration of alkali metal ions except the alkali metal ions derived from neutral salts, can be determined in a simplified manner by measuring the consumption of an acid at pH 4.8. In the invention, the M-alkalinity of the liquid in the final tank is desirably measured continuously with an automatic measurement device.

To determine the M-alkalinity, the liquid is automatically titrated against a 0.1 or 0.05 N sulfuric acid solution using phenolphthalein as an indicator and the amount of sulfuric acid consumed until the pH reaches 4.8 is converted to the amount of CaCO₃.

In the invention, an alkali is added to the upstream aerobic tank(s) so that the M-alkalinity of the liquid in the final tank measured in the above manner will be not more than 50 mg/L as CaCO₃, preferably 0 to 50 mg/L as CaCO₃, and more preferably 10 to 30 mg/L as CaCO₃.

In the invention, as described above, the amount of a neutralizer added to the upstream biological treatment tank is controlled based on the M-alkalinity of the liquid in the final tank. The control is preferably based on the M-alkalinity and also on the pH value in the biological treatment tank in which the neutralizer addition takes place. In this case, the carbon dioxide generated in the final aerobic tank may be removed by aeration taking advantage of the aforementioned facts that the amount of carbon dioxide produced by the biological reaction is small and the pH is low. In this case, the amount of carbon dioxide released by aeration surpasses the amount of carbon dioxide produced by the biological reaction in the final tank with the result that the pH tends to increase. In the expectation of such a pH increase, the pH in the upstream aerobic tank in which neutralization is performed is advantageously controlled to a low value while still ensuring that the biological activity is maintained, thus effectively attaining a reduction in the amount of an alkali.

From the above point of view, the treatment mode (1) is appropriately controlled in the following manner as an example.

The pH in the first-stage aerobic tank is controlled preferably to 5.0 to 7.0, more preferably 5.5 to 6.5. In other words, the pH is controlled preferably so as not to fall below 5.0, more preferably not to fall below approximately 5.5 so that the biological activity will be maintained. At the same time, the pH is controlled preferably so as not to exceed 7.0, more preferably not to exceed approximately 6.5 so that the M-alkalinity in the final tank will be low. Even this control ensures that the biological treatment in the final aerobic tank will take place satisfactorily without a significant decrease in pH.

When the system includes a nitrification tank as in the treatment mode (2) or (3), the pH in the nitrification tank is controlled preferably to as low as possible while still ensuring that the biological activity will be maintained. Because the pH in the nitrification tank is decreased easily by the formation of nitric acid from the nitrification reaction, the above control ensures that the biological activity is sufficiently maintained in the other tanks. Based on this, the control is appropriately performed in the following manner. The pH in the nitrification tank is controlled preferably to 5.5 to 6.5, more preferably 6.0 to 6.5. In other words, the pH is controlled preferably so as not to fall below 5.5, more preferably not to fall below approximately 6.0 so that the biological activity will be maintained. At the same time, the pH is controlled preferably so as not to exceed 6.8, more preferably not to exceed approximately 6.5 so that the M-alkalinity in the final tank will be low. This control ensures that the biological treatment will take place satisfactorily while attaining a reduction in the amount of an alkali.

In the treatment mode (2), as described above, the liquid in the final tank can attain an M-alkalinity of not more than 50 mg/L as CaCO₃ when the pH in the reaeration tank is not more than 6.5. Thus, the pH in the nitrification tank in this treatment mode is preferably controlled to 5.5 to 6.5, more preferably 6.0 to 6.5. Further, the pH adjustment in the nitrification tank may be omitted and the pH may be controlled only in the upstream aerobic tank or only in the upstream aerobic tank and the denitrification tank. In this manner, the amount of a neutralizer may be reduced.

In the case of the treatment mode (3), the increase in M-alkalinity by denitrification reaction is not experienced in contrast to the treatment mode (2) and thus the control may be performed in the following manner. Provided that the properties of the raw water are stable (for example, the variations in TOC and T-N are both within ±15% and the variation in the flow rate of the raw water is within ±15%), the M-alkalinity of the liquid in the final tank has a certain correlation with the pH of the liquid in the aerobic tank in which alkali addition takes place. Thus, the amount in which an alkali is added may be controlled based on the correlation previously determined by measuring the M-alkalinity of the liquid in the final tank and the pH of the liquid in the aerobic tank in which the addition of an alkali is made. The M-alkalinity of the liquid in the final tank has the following relation with the pH in the nitrification tank. Based on the relation, the treatment system may be set so that an alkali reagent is automatically poured to the aerobic tank and/or the nitrification tank while still ensuring that the pH in the nitrification tank does not exceed 6.5.

pH: 5.5→M-alkalinity: 5 to 6

pH: 6.0→M-alkalinity: 21 to 25

pH: 6.5→M-alkalinity: 46 to 49

pH: 7.0→M-alkalinity: 66 to 69

pH: 7.5→M-alkalinity: 148 to 154

[Advanced Treatments]

According to the present invention, the amount of a neutralizer used in the biological treatment can be reduced. This makes the invention particularly effective when advanced treatments such as coagulation separation, RO membrane separation and ion exchange treatment are performed in later stages of the biological treatment. As described hereinabove, the invention attains effects such as the reduction in the amount of an inorganic coagulant used in the coagulation treatment, and less salt loads in the RO membrane separation and the ion exchange treatment.

Treated water obtained by subjecting the biologically treated water according to the invention to advanced treatments may be recovered and reused as, for example, washing water in the manufacturing of electronic devices or as raw water for the washing water.

### EXAMPLES

The present invention will be described in further detail by presenting Examples and Comparative Examples below.

The organic wastewater (raw water) treated in Examples and Comparative Examples below was wastewater from a manufacturing process of liquid crystal panels, and had the following composition and properties.

[Composition and Properties of Raw Water]

### <Composition>

Monoethanolamine: 300 mg/L

Diethylene glycol monobutyl ether: 250 mg/L

Tetramethylammonium hydroxide (TMAH): 50 mg/L

<Properties>

pH: 10.5

TOC: 292 mg/L

T-N: 77 mg/L

The raw water was subjected to biological treatment after the addition of 6 mg/L in terms of P of a phosphorus source required for the biological treatment.

[Example 1 and Comparative Example 1]

The biological treatment of the raw water was carried out by the treatment mode (1) without nitrogen removal as shown in FIG. 1. The raw water was biologically treated by being passed sequentially through the aerobic tank 1A and the aerobic tank 1B, and thereafter solid liquid separation was performed in the sedimentation tank 2. The total hydraulic retention time (HRT) in the tanks 1A and 1B was 24 hr.

### Example 1

During the treatment, NaOH was added to the upstream aerobic tank 1A while monitoring the M-alkalinity in the aerobic tank 1B that was the final tank, so that the M-alkalinity of the liquid in the aerobic tank 1B would be not more than 30 mg/L as CaCO₃. As a result, the pH in the aerobic tank 1A varied in the range of 6.8 to 7.0.

### Comparative Example 1

During the treatment, NaOH was added to the aerobic tanks 1A and 1B so that the pH in each of the aerobic tanks 1A and 1B would be not less than 7.0. As a result, the pH in the aerobic tank 1A varied in the range of 7.0 to 7.2.

Table 1 describes the pH in the aerobic tanks 1A and 1B, the M-alkalinity in the aerobic tank 1B, and the amount of NaOH used for the treatment per 1 L of the raw water in Example 1 and Comparative Example 1.

The treated water (the water separated in the sedimentation tank) obtained in Example 1 and Comparative Example 1 had substantially the same quality.

TABLE 1

| | | | Comparative |
|---|---|---|---|
| | | Example 1 | Example 1 |
| Aerobic tank 1A | pH | 6.8~7.0 | 7.0~7.2 |
| Aerobic tank 1B | pH | 6.4~6.5 | 6.8~7.0 |
| | M-alkalinity | 30 | 100 |
| | (mg/L as CaCO₃) | | |

| | | |
|---|---|---|
| Amount of NaOH (mg/L) | 120 | 400 |

The following can be drawn from the above results.

According to the treatment by the mode (1), the amount of NaOH used for neutralization in Example 1 decreased to 30% of Comparative Example 1. It is thus shown that the control of pH based on the M-alkalinity in the final tank is effective for reducing the amount of a neutralizer.

The biologically treated water (the water separated in the sedimentation tank) obtained by Example 1 and Comparative Example 1 both employing the treatment mode (1) was respectively coagulated by the addition of ferric chloride. In Example 1, the coagulation treatment was accomplished with ⅓ of the amount of ferric chloride used in Comparative Example 1. It is thus confirmed that the reduction in the amount of an alkali in the biological treatment allows the downstream coagulation treatment to be performed with a reduced amount of an inorganic coagulant.

[Examples 2 to 4 and Comparative Example 2]

The biological treatment of the raw water was carried out by the treatment mode (2) with nitrogen removal as shown in FIG. 2. The raw water was sequentially passed through the aerobic tank 1, the nitrification tank (aerobic tank) 3, the denitrification tank (anaerobic tank) 4 and the reaeration tank (aerobic tank) 5, and thereafter solid liquid separation was performed in the sedimentation tank 2. The conditions under which the water was passed were such that the total HRT in the tanks 1, 3, 4 and 5 was 24 hr.

### Example 2

NaOH was added to the aerobic tank 1 while monitoring the M-alkalinity in the reaeration tank 5 that was the final tank, so that the M-alkalinity of the liquid in the reaeration tank 5 would be not more than 50 mg/L as CaCO₃ and also so that the pH in the aerobic tank 1 would not fall below 6.0. NaOH was added to the nitrification tank 3 so that the pH in the nitrification tank 3 would not fall below 6.0. HCl was added to the denitrification tank 4 so that the pH in the denitrification tank 4 would not exceed 7.5.

### Example 3

NaOH was added to the aerobic tank 1 while monitoring the M-alkalinity in the reaeration tank 5 that was the final tank, so that the M-alkalinity of the liquid in the reaeration tank 5 would be not more than 10 mg/L as CaCO₃ and also so that the pH in the aerobic tank 1 would not fall below 6.0. HCl was added to the denitrification tank 4 so that the pH in the denitrification tank 4 would not exceed 7.5.

### Example 4

NaOH was added to the aerobic tank 1 while monitoring the M-alkalinity in the reaeration tank 5 that was the final tank, so that the M-alkalinity of the liquid in the reaeration tank 5 would be not more than 30 mg/L as CaCO₃ and also so that the pH in the aerobic tank 1 would not fall below 6.0.

### Comparative Example 2

NaOH was added to the aerobic tank 1 and the nitrification tank 3 without monitoring the M-alkalinity in the reaeration tank 5 that was the final tank, so that the pH in the aerobic tank 1 and that in the nitrification tank 3 would not fall below 6.5. HCl was added to the denitrification tank 4 so that the pH in the denitrification tank 4 would not exceed 7.5. HCl was added to the reaeration tank so that the pH in the reaeration tank would not exceed 8.0.

Table 2 describes the pH values in the respective reaction tanks, the M-alkalinity, the amounts of HCl and NaOH used for the treatment per 1 L of the raw water, and the quality of the biologically treated water obtained in Examples 2 to 4 and Comparative Example 2.

TABLE 2

| | | | | | Compar- |
|---|---|---|---|---|---|
| | | Example | Example | Example | ative |
| | | 2 | 3 | 4 | Example 2 |
| Aerobic tank | pH | 6.0~6.3 | 6.0~6.3 | 6.0~6.3 | 6.5~6.9 |
| Nitrification | pH | 6.2~6.5 | 6.0~6.3 | 6.0~6.3 | 6.5~6.6 |
| tank | | | | | |
| Denitrification | pH | 7.2~7.5 | 7.3~7.5 | 7.5~7.7 | 7.3~7.5 |
| tank | | | | | |
| Final tank | pH | 6.4~6.6 | 5.9~6.1 | 6.2~6.4 | 7.9~8.0 |
| | M-alkalinity | 50 | 10 | 30 | 155 |
| | (mg/L as | | | | |
| | CaCO₃) | | | | |
| Amount of NaOH (mg/L) | | 380 | 200 | 200 | 500 |
| Amount of HCl (mg/L) | | 50 | 20 | 0 | 70 |
| Treated water | TOC (mg/L) | 5.0 | 5.3 | 5.3 | 5.0 |
| | NH₄—N (mg/L) | <0.1 | 0.5 | 0.5 | <0.1 |

The following can be drawn from the above results.

The treatment by the mode (2) in Example 2 was performed while maintaining the M-alkalinity in the final tank to a low level as compared to Comparative Example 2, and consequently the amounts of NaOH and HCl used for neutralization were reduced.

As compared to Example 2, Example 3 attained approximately 50% reduction in the amount of NaOH used for neutralization and also achieved about 60% reduction in the amount of HCl. The concentration of NH₄—N in the treated water in Example 3 was as low as 0.5 mg/L, although slightly higher than that in Example 2.

While the M-alkalinity in the final tank in Example 4 was a little higher than in Example 3, the amount of NaOH used for neutralization was equal to that in Example 3. No HCl was used in Example 4. The concentration of NH₄—N in the treated water in Example 4 was as low as that in Example 3.

As discussed above, Examples 2 to 4 attained a reduction in the amounts of NaOH and HCl used for neutralization as compared to Comparative Example 2. It has been demonstrated that the mode of biological treatment which does not involve neutralization in the nitrification tank as is the case in Examples 3 and 4 provides sufficient removal of NH₄—N except when the treated water should be highly cleaned of NH₄—N, and also makes it possible to realize further reduction in the amounts of NaOH and HCl.

The mode used in Example 4 may be adopted provided that the pH adjustment can control the M-alkalinity to stay in the prescribed range. If the M-alkalinity is caused to exceed the prescribed range, it is preferable to adopt the mode of Example 3 which involves pH adjustment in the extra tank.

The biologically treated water (the water separated in the sedimentation tank) obtained by the treatment mode (2) was coagulated by the addition of a polysulfate salt, and the water from the coagulation treatment were subjected to ion exchange treatment. In Example 4, the coagulation treatment was accomplished with ¼ of the amount of the polysulfate salt used in Comparative Example 2, and the frequency of the regeneration of the ion exchange resin used in the subsequent ion exchange treatment was reduced to ¼. It has been thus confirmed that the reduction in the amount of a neutralizer in the biological treatment allows the downstream coagulation treatment to be performed with a reduced amount of an inorganic coagulant and also makes it possible to reduce the frequency with which the ion exchange resin used in the ion exchange treatment is regenerated.

Although the present invention has been described in detail with respect to some specific embodiments, the skilled person will appreciate that various modifications are possible within the spirit and scope of the invention.

This application is based upon Japanese Patent Application No. 2014-187799 filed on Sep. 16, 2014, the entire contents of which are incorporated herein by reference.

### REFERENCE SIGNS LIST

1, 1A, 1B AEROBIC TANK
2 SEDIMENTATION TANK
3 NITRIFICATION TANK
4 DENITRIFICATION TANK
5 REAERATION TANK

1.-12. (canceled)

13. A biological treatment method comprising passing organic wastewater from a manufacturing process of electronic devices sequentially through two or more biological treatment tanks arranged in series, wherein
at least two tanks of the two or more biological treatment tanks are aerobic biological treatment tanks,
one of the aerobic biological treatment tanks is a final-stage biological treatment tank,
a pH in at least one biological treatment tank other than the final-stage biological treatment tank is adjusted by adding an acid or an alkali,
the treated water discharged from the final-stage biological treatment tank is subjected to at least one advanced treatment process selected from coagulation separation, reverse osmosis membrane separation, and ion exchange treatment, and
an addition amount of the acid or the alkali is controlled so that an M-alkalinity of a liquid in the final-stage biological treatment tank is maintained at not more than 30 mg/L as CaCO₃ and that an M-alkalinity of a liquid fed to the advanced treatment process is maintained at not more than 30 mg/L as CaCO₃.

14. The biological treatment method according to claim 13, wherein the addition amount of the acid or the alkali is controlled based on the M-alkalinity of the liquid in the final-stage biological treatment tank.

15. The biological treatment method according to claim 13,
wherein the at least two biological treatment tanks include an aerobic tank, nitrification tank, and a reaeration tank, the organic waste water being passed in this order,
wherein the addition amount of the acid or the alkali is controlled based on a correlation previously determined with respect to the M-alkalinity of the liquid in the reaeration tank of the final-stage biological treatment tank, and
wherein the indicator correlated with the M-alkalinity is the pH of the liquid in the aerobic tank to which the acid or the alkali is added, and the addition amount of the acid or the alkali is controlled based on a correlation previously determined with respect to the M-alkalinity and the pH.

16. The biological treatment method according to claim 13, wherein the aerobic biological treatment tank(s) other than the final-stage biological treatment tank is a nitrification tank, and the pH in the nitrification tank is controlled to be not less than a prescribed value.

17. The biological treatment method according to claim 13, further comprising recovering and reusing the water treated by the advanced treatment process.

18. A biological treatment apparatus comprising two or more biological treatment tanks arranged in series through which organic wastewater from a process of manufacturing electronic devices is sequentially passed, wherein
at least two tanks of the two or more biological treatment tanks are aerobic biological treatment tanks,
one of the aerobic biological treatment tanks is a final-stage biological treatment tank,
at least one biological treatment tank other than the final-stage biological treatment tank has a pH adjusting unit that adjusts the pH by adding an acid or an alkali,
the apparatus includes at least one advanced treatment unit selected from a coagulation separation unit, a reverse osmosis membrane separation unit and an ion exchange treatment unit so that the advanced treatment unit treats treated water discharged from the final-stage biological treatment tank, and
the apparatus includes a controller for controlling an addition amount of the acid or the alkali by the pH adjusting unit so that an M-alkalinity of a liquid in the final-stage biological treatment tank is maintained at not more than 50 mg/L as CaCO₃.

19. The biological treatment apparatus according to claim 18, wherein the controller controls the addition amount of the acid or the alkali by the pH adjusting unit based on the M-alkalinity of the liquid in the final-stage biological treatment tank or an indicator correlated with the M-alkalinity.

20. The biological treatment apparatus according to claim 19,
wherein the at least two biological treatment tanks include an aerobic tank, nitrification tank, and a reaeration tank, the organic waste water being passed in this order,
wherein the addition amount of the acid or the alkali is controlled based on a correlation previously determined with respect to the M-alkalinity of the liquid in the reaeration tank of the final-stage biological treatment tank, and
wherein the indicator correlated with the M-alkalinity is the pH of the liquid in the aerobic tank to which the acid or the alkali is added, and the controller controls the addition amount of the acid or the alkali by the pH adjusting unit based on a correlation previously determined with respect to the M-alkalinity and the pH.

21. The biological treatment apparatus according to claim 18, wherein the aerobic biological treatment tank(s) other than the final-stage biological treatment tank is a nitrification tank, and the apparatus includes a controller that controls the pH in the nitrification tank to be not less than a prescribed value.

22. The biological treatment apparatus according to claim 18, wherein the apparatus includes a recovery unit that recovers the treated water from the advanced treatment unit so that the water recovered is reused.
